(19) United States
(12) Patent Application Publication
(10) Pub. No.: US 2015/0093208 A1
(43) Pub. Date: Apr. 2, 2015

(54) Unit for Duplicating Recesses of a Cylindrical Key

(71) Applicant: Artur Litwinski, Warszawa (PL)

(72) Inventor: Artur Litwinski, Warszawa (PL)

(21) Appl. No.: 14/500,118

(22) Filed: Sep. 29, 2014

(30) Foreign Application Priority Data
Sep. 30, 2013 (PL) 405 475

(51) Int. Cl. B23C 3/35

(52) U.S. Cl. CPC B23C 3/355
USPC 409/81

(57) ABSTRACT

It is the object of this invention to provide a unit for duplicating recesses of a key with a cylindrical shank. A unit 1 for duplicating recesses of a key 2 with a cylindrical shank in a duplicating machine, where the key comprises a gripping part 3 and a cylindrical operational shank 4 on the surface of which encoding recesses 5 are made that cooperate with elements to unlock a lock mechanism, such as bolts, and on the outer surface of which, radially to the axis of the key, an abutment 6 is positioned that secures the position of the key 2 in the lock mechanism and transfers driving force from the key 2 to the lock mechanism, where the duplicating machine 7 is provided with two receptacles 8, where in the first receptacle 8 a master key 2 to be duplicated is inserted, and in the other receptacle 8 a blank key 2 is inserted, and the receptacles 8 have a flat key shape in cross-section. The unit 1 has a body 9 with an internal receptacle 10 with a recess 11 for an abutment 6 of the shank 4 of the key 2, where a cylindrical key 2 is inserted, and the unit 1 is provided with elements for securing in a duplicating machine 7.

It is the object of the invention to provide a unit for duplicating recesses in a cylindrical key.

Keys for lock mechanisms constitute a very important element for securing apartments, residence houses, institutions or other facilities. It may happen that a key becomes damaged or lost. In such situation the best and the least expensive solution is to duplicate and make a new key, for example basing on another key of the same set of keys or a spare key.

Very popular and used for many years have been flat keys with a shank and a gripping part where encoding recesses are made, usually in one row. Such keys are duplicated in versatile devices for duplicating keys. A key duplicating machine according to the prior art is shown in FIG. 7. The key duplicating machine has two receptacles where a blank key and the master key are seated. The blank key is placed in one receptacle and the master key in another one. Both receptacles with keys are seated in a support rotationally positioned in the key duplicating machine body and they may be moved radially towards a machining tool and a template. The template is sliding over the master key and makes it possible to duplicate encoding recesses on the blank key. The receptacles of the duplicating machine, where blank key and master key are positioned, have a sectional shape corresponding to the section of the shank of a flat key and this allows for precise seating of the two keys in the duplicating machine and duplicating encoding recesses of one key onto the other one.

This solution however is not suitable directly for duplicating keys with a cylindrical shank where encoding recesses are shaped spatially on the surface of the key shank.

Keys of this kind, which is, keys with a cylindrical shank, may be duplicated in a specialized service utility of the lock and key manufacturer, using machines that are often digitally controlled and reproduce the key being duplicated basing on a numeric code from one positioning of a blank key in the machine.

Key duplication, including using specialized machines, although guarantees high quality of key reproduction, may cause some difficulties for the users, for example due to not dense enough manufacturer's service network who renders services of this kind.

It is the object of this invention to avoid the above mentioned problems and to broaden the scope of devices used for key duplication.

A unit according to this invention is used for duplicating recesses of a key with a cylindrical shank, where the key comprises a gripping part and a cylindrical operating shank on the surface of which there are positioned encoding recesses that cooperate with elements for unlocking of a lock mechanism, such as bolts, and on the outer surface of which, radially relative to the key axis, an abutment is placed for securing the position of the key in the lock mechanism and for transferring driving force from the key to the lock mechanism. The duplicating machine is provided with two receptacles, where in the first receptacle a master key to be duplicated is inserted while in the other receptacle a blank key is inserted, and the receptacles have a flat key shape in cross-section. The unit has a body with an internal receptacle that has a recess for an abutment of the key shank where a cylindrical key is seated, and the unit is provided with elements for securing in the duplicating machine.

Preferably, the internal receptacle of the body has four recesses for the abutment, and the abutment of the key may be placed in each of the recesses.

Preferably, the element for securing the unit in the duplicating machine is constituted by a shaped projection that has a flat key shape in cross-section.

Preferably, the shaped projection of the body is sectioned along a plane extending through the longitudinal axis of the internal receptacle.

Also preferably, the element for securing the unit 1 in the duplicating machine 7 is constituted by a fixing screw 13 extending through the body 9 of the unit 1.

### BRIEF DESCRIPTION OF THE DRAWINGS

The object of the invention is shown in an embodiment in the drawing, where

FIG. 1 shows two units secured in a duplicating machine, in a side view.

FIG. 2 shows a unit in a side view with a cylindrical key therein.

FIG. 3 shows a unit in a side view, with a cylindrical key in the course of being seated therein.

FIG. 4 shows a unit in a cross-sectional view.

FIG. 5 shows a unit in a second embodiment in a side view, with a cylindrical key in the course of being seated in the unit.

FIG. 6 shows a unit in the second embodiment, in a side view, with a cylindrical key seated therein.

FIG. 7 shows a key duplicating machine in the prior art.

### DETAILED DESCRIPTION

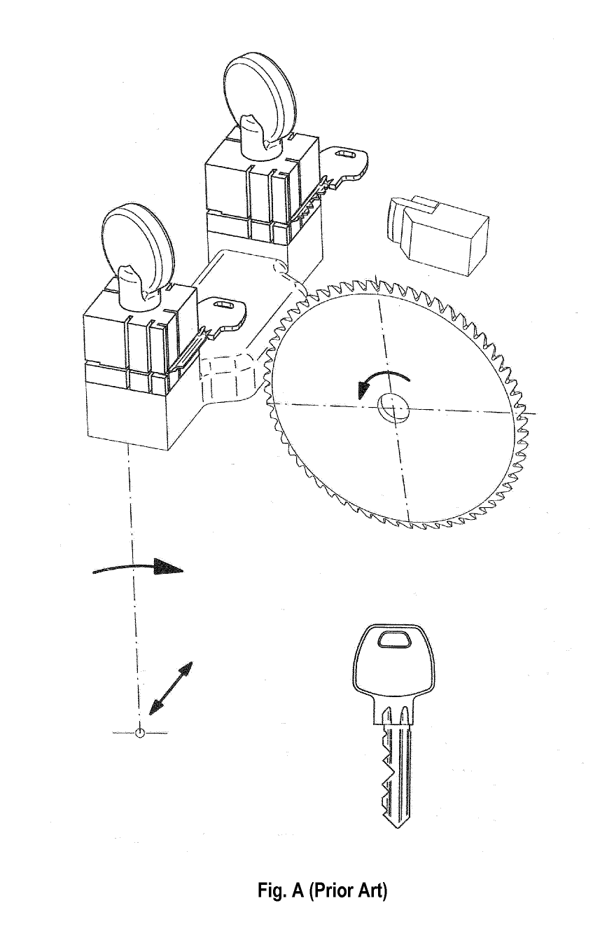

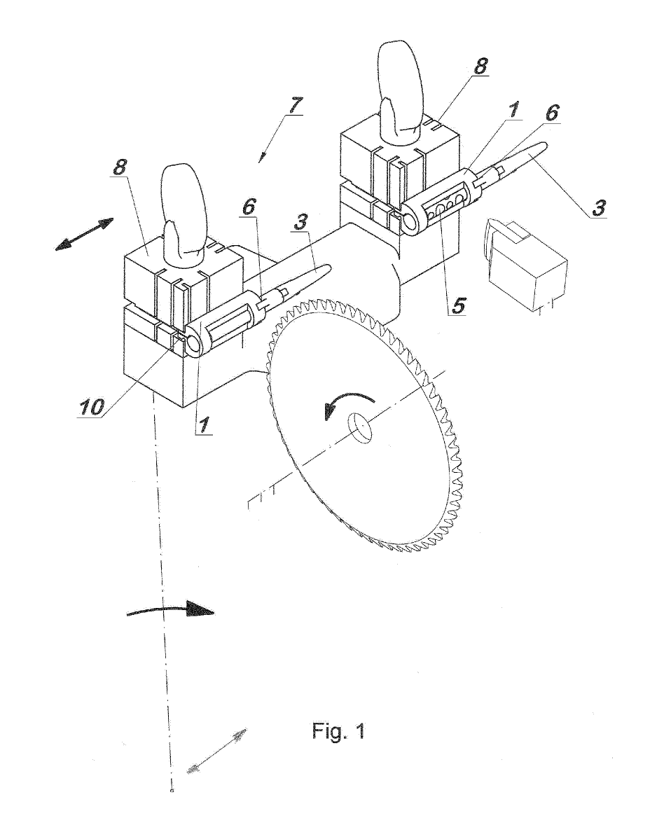

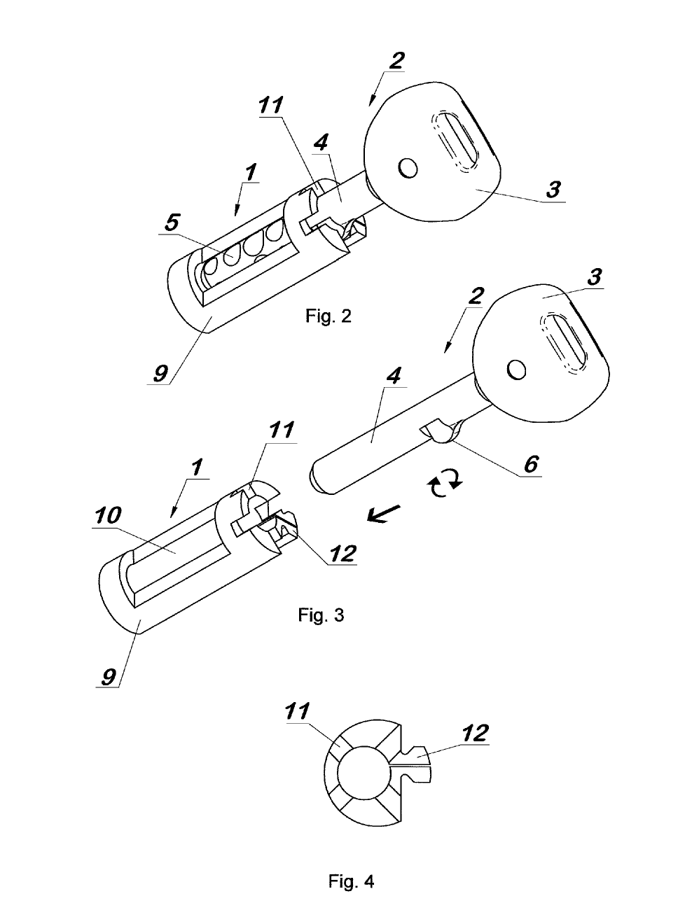

As shown in FIGS. 1 and 2, a unit 1 for duplicating recesses of a key 2, with a gripping part 3 and cylindrical shank 4, has a body 9 where an internal receptacle 10 is formed. In the internal receptacle 10 a blank key 2 is inserted or a master key 2 is inserted. A key 2 with a cylindrical shank has in its cylindrical part an abutment that secures the position of the key 2 within a lock mechanism and transfers driving force from the key 2 to the lock mechanism. On its cylindrical shank, the master key 2 also has encoding recesses 5 that are to be reproduced on the blank key 2.

In order to precisely position the two keys 2 in the units 1, they have in the internal receptacle 10 recesses 11 in which the abutment 6 of the key 2 is inserted. In the embodiment shown, in the units 1 four recesses 11 are made in the internal receptacle 10 to enable positioning of the key 2 in four different angular orientations. As shown in FIG. 4, on the outer surface of the body 9 of the unit 1 a shaped projection 12 is made that has a shape of a flat key in cross-section, to which a duplicating machine 7 is adjusted. This shaped projection has to be located between the recesses 11 so as to enable free inserting of the key 2 in the unit 1.

The shaped projection 12 of the body 9 of the unit 1 is sectioned along to a plane extending through the longitudinal axis of the internal receptacle 10 so as the unit may be compressed while pressing perpendicularly to the outer surface of the shaped projection of the body 9 of the unit 1.

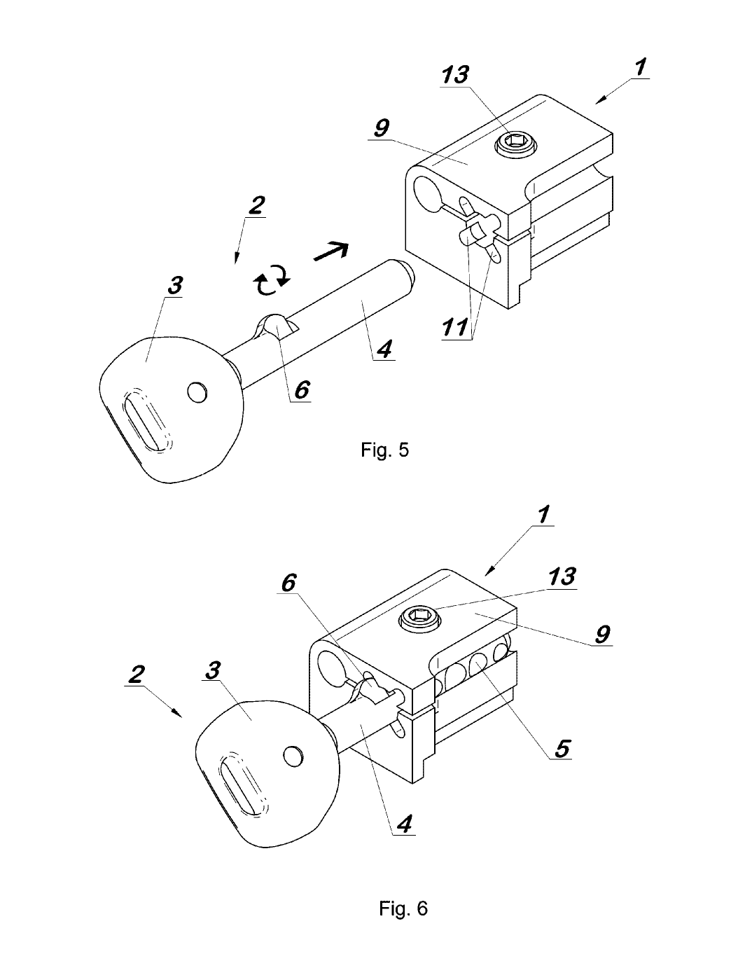

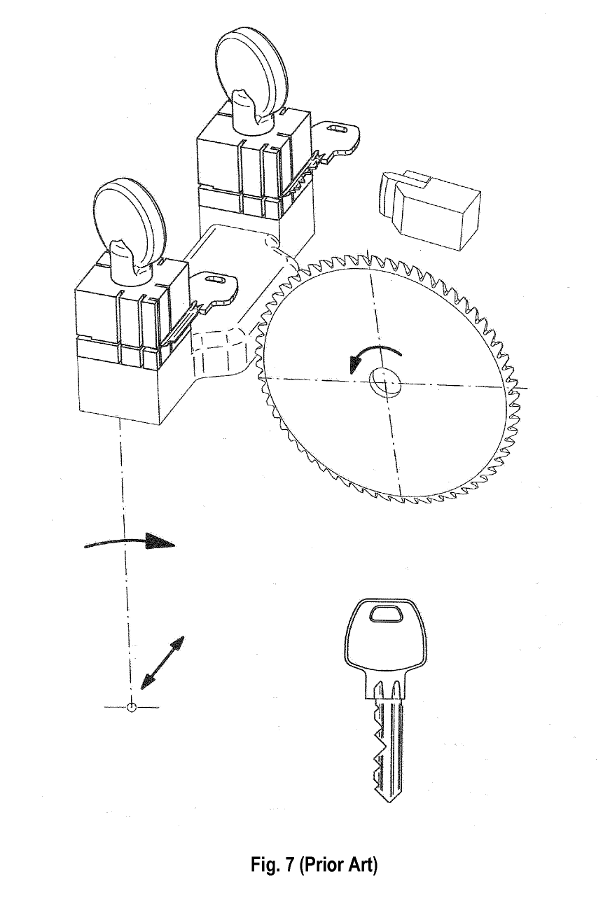

As shown in FIGS. 5 and 6, in another embodiment, a unit 1 has four recesses 11 made in its internal receptacle 10, to enable positioning of a key 2 in four different angular orientations. Through the body 9 of the unit 1 a bore extends substantially perpendicularly to the axis of the receptacle 10, through which a fixing screw 13 extends to secure the unit 1 to a duplicating machine and to immobilize a blank key 2 or a master key 2.

FIG. 1 shows a blank key 2 inserted in one unit 1 and a master key 2 inserted in another unit 1, where the two units 1 with keys 2 are inserted in receptacles 8 of a duplicating machine 7. The receptacles 8 of the duplicating machine 7 are tightened by means of a threaded connection so that they exert a pressure on the shaped projection 12 of the body 9 of the unit 1 and this causes some fixing of the keys 2 in the units 1, and thus in the duplicating machine 7. This enables reproduction of the recesses 5 of one row from the master key 2 on the blank key 2.

Subsequently, the threaded connection of the receptacles 8 to the duplicating machine 7 is loosened, and this allows rotation of the keys 2 in their respective units after having moved them out slightly from the unit, and inserting them with the abutments 6 on the shanks 4 in another recess 11 of the internal receptacles 10, as well as reproducing another row of recesses 5 from the master key 2 to the blank key 2.

As a result of further proceeding in this manner, recesses of all the rows of the master key 2 are reproduced on the blank key 2.

The units 1 with the keys 2 according to the second embodiment are secured to a duplicating machine by means of a fixing screw 13 extending through the body 9 of the unit 1 and screwed into the corresponding threaded opening in the duplicating machine 7, and the procedure for duplicating a key is analogous as in the first embodiment.

I claim:

1. A unit 1 for duplicating recesses of a key 2 with a cylindrical shank in a duplicating machine, where the key comprises a gripping part 3 and a cylindrical operational shank 4, on the surface of which there are positioned encoding recesses 5 that cooperate with elements for unlocking a lock mechanism, such as bolts, and on the outer surface of which, radially to the axis of the key, an abutment 6 is positioned to secure the position of the key 2 in the lock mechanism and to transfer driving force from the key 2 to the lock mechanism, where the duplicating machine 7 is provided with two receptacles 8, where in the first receptacle 8 a master key 2 to be duplicated is inserted, and in the second receptacle 8 a blank key 2 is inserted and the receptacles 8 have a shape of flat key in cross-section, characterized in that it has a body 9 with an internal receptacle 10 with a recess 11 for an abutment 6 of the shank 4 of the key 2, where a cylindrical key 2 is inserted, and the unit 1 is provided with elements for securing in the duplicating machine 7.

2. A unit according to claim 1 characterized in that the internal receptacle 10 of the body 9 has four recesses 11 for the abutment 6, and the abutment 6 of the key 2 may be inserted in each of the recesses 11.

3. A unit according to claim 1 characterized in that the element for securing the unit 1 in the duplicating machine 7 is constituted by a shaped projection 12, that has a shape of a flat key in cross-section.

4. A unit according to claim 3 characterized in that the shaped projection 12 of the body 9 is sectioned along a plane extending through the longitudinal axis of the internal receptacle 10.

5. A unit according to claim 1 characterized in that the element for securing the unit 1 in the duplicating machine 7 is constituted by a fixing screw 13 extending through the body 9 of the unit 1.
